(19) United States
(12) Patent Application Publication
(10) Pub. No.: US 2023/0274124 A1
(43) Pub. Date: Aug. 31, 2023

(54) HYBRID INDUCTIVE-DEDUCTIVE ARTIFICIAL INTELLIGENCE SYSTEM

(71) Applicant: George Moser, Santa Clara, CA (US)

(72) Inventor: George Moser, Santa Clara, CA (US)

(21) Appl. No.: 17/682,662

(22) Filed: Feb. 28, 2022

(51) Int. Cl. G06N 3/00; G06N 3/08

(52) U.S. Cl. CPC G06N 3/006; G06N 3/08

(57) ABSTRACT

A hybrid artificial intelligence system is provided to emulate human problem-solving skills in determining a solution to computation problems. One or more inductive artificial intelligence modules process data to extract features and patterns, which are stored in a methods library. A deductive artificial intelligence module captures working principles in the methods library. A resolution algorithm searches the methods library to identify a possible solution.

### FIELD OF THE INVENTION

The present invention relates to the field of Artificial Intelligence (AI).

### BACKGROUND

Artificial Intelligence (AI) is a technology that will have a deep impact on society in the coming years. The upcoming widespread implementation of AI is primarily a consequence of better data availability because of the Internet and millions of connected devices, better computing performance and significant breakthroughs in machine learning with useful AI software modules becoming widely available.

Artificial Intelligence has made big strides in recent years, especially in Machine Learning. FIG. 1 is used to describe the state of the art in this area. FIG. 1 shows a prior art neural network which is a typical machine learning configuration used to teach a machine human-like behavior using data mining. The name neural network comes from the fact that this network intends to emulate the functioning of a human brain. It consists of a plurality of nodes or cells, such as nodes 13 through 17, which replicate the role of neurons in a human brain. The nodes on the left side of FIG. 1 (within the rectangular area identified by the numeral 10) are the input nodes, while the nodes shown inside the rectangular area 12 are the output nodes. Just as their names describe them, their function is to receive user input in form of data and to generate output for the user in form of results, which can be categorical results (such as identifying a human face or not, represented by 1 or 0) or continuous results (such as providing a prediction within a numerical range). The nodes in the central rectangular area 11 are part of the hidden layers, which is where the computations are performed. To that effect, each node is assigned a weight and a bias, which are used to extract features and patterns through mathematical calculations such as statistical regression, curve fitting and others.

The data fed into the neural network is typically complex and often consists of multi-dimensional arrays called tensors, which are matrices that contain the attributes that will be analyzed by the neural network to extract features and patterns (such as character recognition or voice identification).

An AI network typically requires a large amount of data to perform its function. The computational resources required are also very high, and often require GPU's (graphical processing units) rather than conventional CPU's to be able to perform the tasks at hand without having to wait weeks or months for results.

The neural network needs to be trained before it can be used to perform its intended function. To that effect the data is typically split into two subsets, one for training (maybe 90% of the data set) and one for testing (maybe the remaining 10%). The training dataset is then fed into the network and processed in training mode. This can be a long and massive undertaking in data mining. The objective of the training is to reduce the entropy or randomness of the results, until a convergence is achieved.

After the training is completed a validation phase is used to test the predictive value and accuracy of the model.

The results are often astounding in quality and accuracy. Natural language processing, voice recognition, voice generation, image processing and face recognition are some of the areas where impressive results have been achieved.

### SUMMARY

The previously described neural networks and machine learning are ideal for problems with large amounts of data that can be methodically mined to extract features and patterns. The data can be processed by a neural/machine learning/deep learning network to extract said features and patterns, and then draw conclusions. That is an example of inductive artificial intelligence, where numerous data sets are observed and processed to make inferences. However, some problems do not have a large body of data to process and draw inferences from. In those situations, deductive artificial intelligence can be used. Instead of data mining through a large database, deductive AI uses an already existing body of knowledge in form of working principles, experience and known rules of thumb to apply to the problem and draw conclusions as to what needs to be done.

Both approaches (deductive AI and inductive AI) are valuable and useful. The present invention combines both approaches into a Hybrid Artificial Intelligence System (HATS), using the most appropriate approach for each facet of the problem, as shown in FIG. 3. For example, for the user interface between the user and the AI system, a data-based approach can be used in form of a neural network to enable natural language communication, an area where neural networks excel. For decisions about the next step in a complex process, for which a large database of previous samples and instances may not exist or may be too difficult or time-consuming to create, deductive artificial intelligence based on empirical knowledge and decision trees (such as if-then-else rules of thumb) can be used. In the real world, deductive intelligence is commonly used by humans. For instance, if a tech support technician is trying to help a customer whose computer is running too slow, he/she will probably rely on his/her previous experience to make that decision. The technician will probably build a decision tree in his/her head, which may look like this:

Let us first find out if the hard disk is too full. IF the hard disk is over 90% full, THEN check if all data has been backed up before making any changes. IF the data is not fully backed up, THEN let us perform a backup on the cloud for safety. IF the cloud backup is completed, THEN let us start deleting unnecessary files from the hard disk to free up operating space. IF the deletion of unnecessary files is completed, THEN check again for available space and THEN check computer speed again. IF computer speed is still too low, THEN let us close apps running in the background, and so on.

That sequence of IF_THEN statements and actions constitutes an empirical decision tree that the technician builds to tackle the problem. It is a normal way that humans approach problems, based on experience. That is the reason experience is so important and valuable when hiring humans, because if the person already has dealt with similar problems, it is logical to expect that he/she will be able to draw from that body of experience and build good decision trees when confronted with similar problems in the future. A machine can do it too when properly programmed and fed the empirical knowledge.

The novel hybrid AI system of this invention, which combines both types of artificial intelligence, inductive and deductive, provides major advantages in terms of practicality, cost, time effectiveness and feasibility of implementation. Tasks that are best suited to data based inductive AI are resolved that way, while tasks that are better suited to deductive AI based on empirical methods use that approach, with both types of AI interfacing, communicating, and collaborating in the process.

Another key novel aspect of the present invention is the ability to execute a course of action, not just dispense information, as shown in FIG. 4. This invention discloses an artificial intelligence system that not only has the ability to process data and reason like a human mind using both deductive and inductive intelligence, but also has the capability to execute a course of action. Such a system will be called an Artificial Intelligence Motor (AIM) in this invention. The AIM concept is applicable in many areas, such as for example in Technical Support, which is one of the preferred areas of implementation. In traditional technical support, a user would call or message a technical support center where he would eventually connect with a human who would listen for a description of the problem and then give ideas how to solve it. In a more modern version of technical support, the user would message a technical support center where a chatbot would act as a gateway, trying to understand the problem description and identify/classify the problem, in order to either refer the user to FAQ (frequently asked questions) or if the problem is unusual or unknown to the chatbot, switch to a human operator. In the future, advanced AI technical support according to the present invention will have an artificial intelligence motor who will:
listen to the problem using Natural Language Processing;
search for a possible solution in its Method Library;
request user permission to temporarily take over the device to make changes needed to implement the possible solution;
temporarily take over control of the device using remote access software and/or device resident software;
backup current status before making changes to be able to revert back if necessary;
implement the solution;
relinquish device control back to user and report the outcome; and
ask for further user instructions.

The new Technical Support based on this invention is a radical departure from previous approaches. Under the previous approach, tech support was primarily a gateway to route users to either human tech support or to an advisor. Under the new approach of this invention, Tech Support becomes become an acting, executing agent for the user, who will not just dispense information, advice and ideas about the problem, but who will actually resolve it. Such as tech support is not just a talker, but a doer. Of course, AIM can talk too. That is an important capability, because the AIM Tech Support by default will look like a human and talk like a human (unless the user prefers to choose the appearance like a robot, which is a user choice).

### BRIEF DESCRIPTION OF THE DRAWINGS

FIG. 1 shows a prior art artificial intelligence neural network.

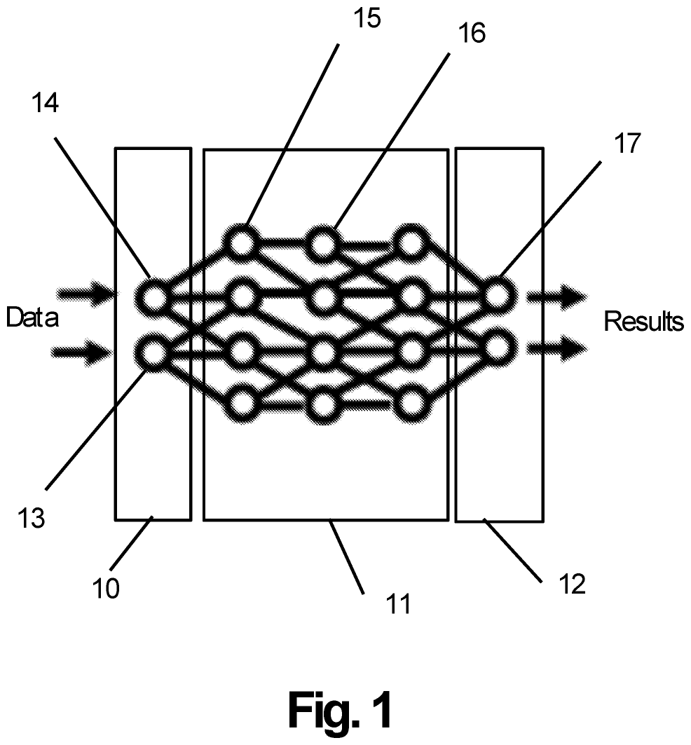

FIG. 2 shows some of the personalization/customization options for the assigned human representation of the Artificial Intelligence system of this invention.

FIG. 3 shows the flow diagram for the hybrid artificial intelligence system of this invention.

FIG. 4 shows a flow diagram for the Artificial Intelligence Motor of this invention.

FIG. 5 shows the artificial intelligence motor for Technical Support (called Techy in its default assigned human appearance), which is a new software generation intended to supersede and replace prior art tech support chatbots.

FIG. 6 shows the artificial intelligence motor for an Operations Manager (called Timely in its default assigned human appearance), which is a new software generation intended to supersede and replace prior art virtual assistants.

FIG. 7 shows the flow diagram for an Artificial Intelligence application (called Coach in its default assigned human appearance), which discloses the concept of responsive videos and tutorials of this invention.

FIG. 8 shows an Artificial Intelligence web website which is used to make the novel and unique inventions disclosed in this patent available to the public based on different revenue models such as a subscription service (SAAS— software as a service) and others.

### DETAILED DESCRIPTION

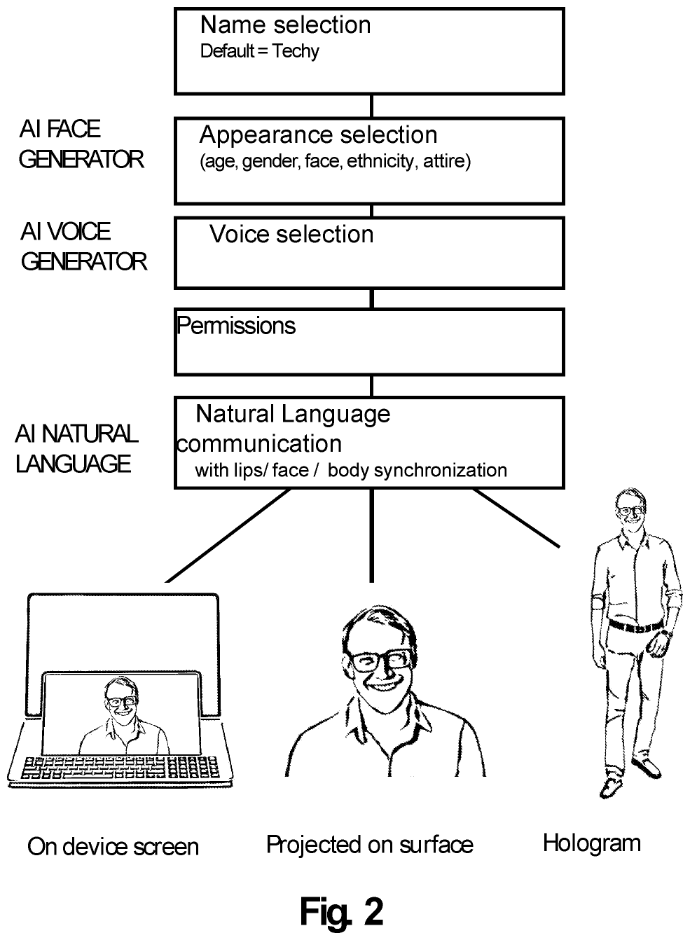

As shown in FIG. 2, to create comfort, trust and familiarity with the user, the AIM Tech Support will have a default name, which is Techy at this point, but the user can choose and assign any different name he/she prefers. Techy will also have a default appearance, but the user can select any desired appearance from an included AI appearance generator. Techy will have a default voice but the user can choose any desired voice from the included AI voice generator. The user can choose name, gender, voice, language, accent, age, appearance, ethnicity, attire(s), and other features. Techy will listen, provide feedback, and talk with the user using Natural Language. Techy's image will move its lips, face and body in perfect natural synchronization with Techy's image on the device screen. Techy can be completely customized by the user, which also provides security advantages because the user will be able to recognize and authorize Techy. Techy will be able to communicate using a device screen such as a laptop, tablet, or smart phone or other smart devices, or by projecting an image of any desired size, such as normal human size, on a surface such as a wall or on a projection screen, or through a hologram. The preferred communication method with the user will be natural language, but messaging will also be supported too for those cases where it may be necessary or desirable.

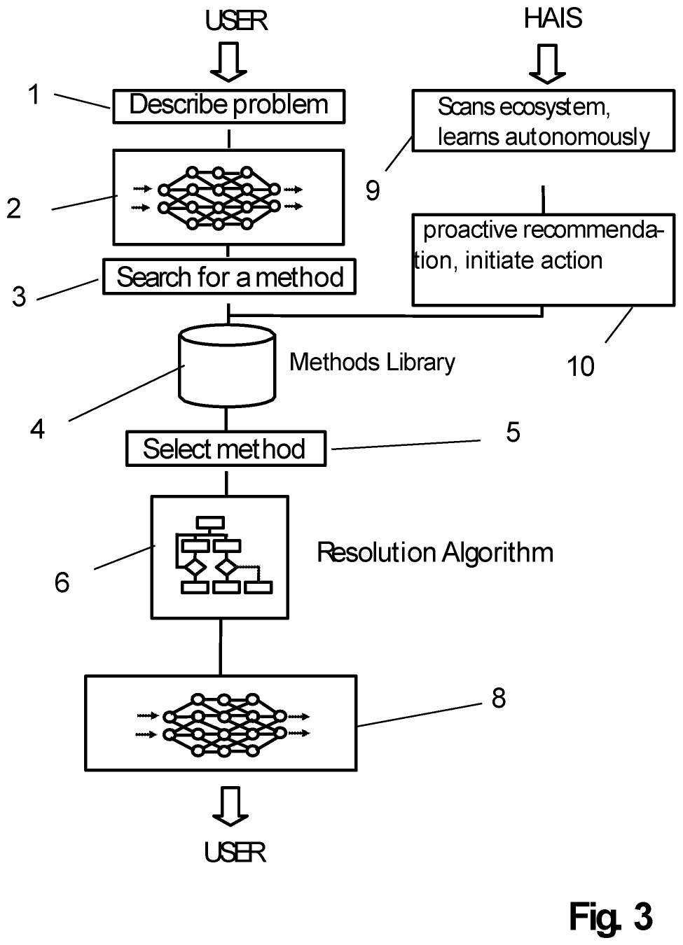

FIG. 3 describes the general structure of a Hybrid Artificial Intelligence System (HATS), as conceived and disclosed in this invention. In step 1, the user communicates with the HAIS system using natural language and describes a problem that needs to be addressed. A neural network 2 is used to provide the required natural language capabilities for HAIS to understand the problem description. In step 3, HAIS searches for a possible method to resolve the problem in a previously created Methods Library 4, which contains a collection of empirical methods to address problems in the competence area of this particular HAIS system. The methods in the Methods Library often will be a collection of decision trees of the general shape if_then_else or other logical description that defines how to logically and methodically search step by step for a solution to the problem at hand.

Another important novel feature of an AIM system is the optional capability for the system to initiate action itself. Therefore, there are two ways action can be initiated: a) by the USER (as previously described above) or b) by the Hybrid Artificial Intelligence System (HATS) itself, as shown on the top right branch of the flow diagram. The HAIS system constantly scans the ecosystem it operates in (step 9), and autonomously learns from it (step 10). The lessons learned from this process are stored in the Methods Library 4. This capability allows the AIM system to initiate action by itself, and proactively make a suggestion to the user or issue a recommendation. This capability is explained in more detail later in this document.

In step 5, the HAIS system selects a method or a combination of methods that appear like a possible good approach to address the problem at hand. In step 6, HAIS will use its resolution algorithm 6 to navigate through the decision tree of the selected method and attempt to find a solution.

In the last step 8, HAIS reports to the user the outcome of its work. This communication with the user is typically through natural language using a neural network.

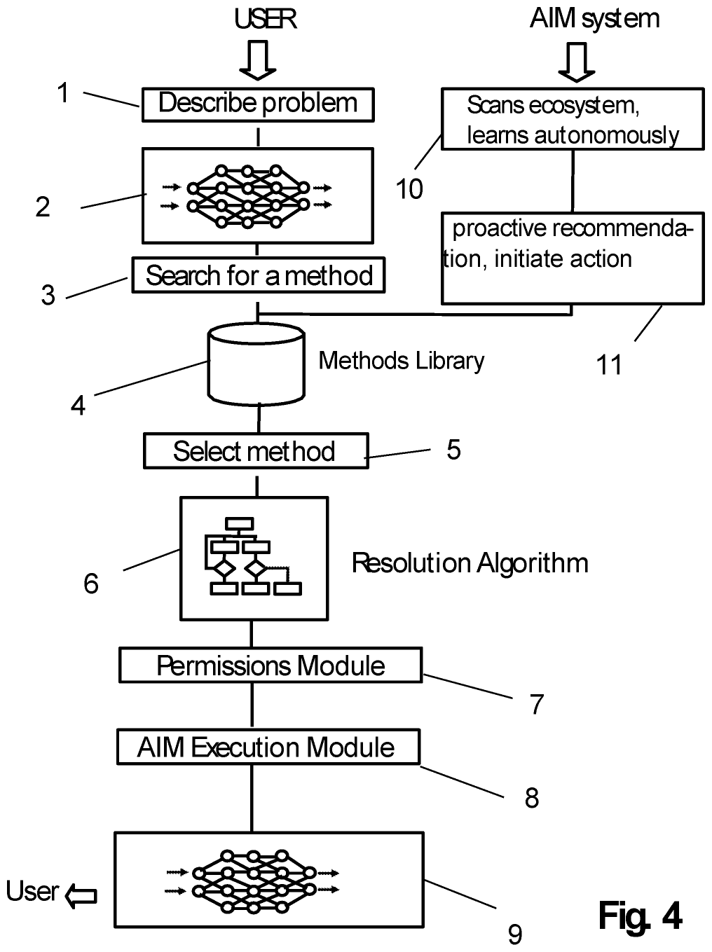

FIG. 4 describes the general structure of an artificial intelligence motor (AIM), as conceived and disclosed in this invention. An artificial Intelligence motor is an artificial intelligence system that can actually implement the solution found, as opposed to just reporting and explaining the solution found. In step 1, the user communicates with the AIM system using natural language and describes a problem that needs to be addressed. A neural network 2 is used to provide the required natural language capabilities for AIM to understand the problem description. In step 3, AIM searches for a possible method to resolve the problem in a previously created Methods Library 4, which contains a collection of empirical methods to address problems in the competence area of this particular AIM system. The methods in the Methods Library often will be a collection of decision trees of the general shape if_then_else or other logical description that defines how to logically and methodically search step by step for a solution to the problem at hand.

Another important optional feature of an AIM system is the ability for the system to initiate action itself. Therefore, there are two ways action can be initiated: a) by the USER (as previously described above) or b) by the AIM system itself, as shown on the top right branch of the flow diagram. The AIM system constantly scans the ecosystem it operates in (step 10), and autonomously learns from it. The lessons learned from this process are stored in the Methods Library. This capability allows the AIM system to initiate action by itself, and proactively make a suggestion to the user or issue a recommendation (step 11). This capability is explained in more detail later in this document using two implementations of AIM (one called Techy for Tech Support and another one called Timely for an Operations Manager).

In step 5, the AIM system selects a method or a combination of methods that appear like a possible good approach to address the problem at hand, and then in step 6, the AIM Resolution Algorithm searches in the Methods Library and finds the best available solution. In step 7, the system requests permission from the user to implement the best solution found. If permission is not granted, AIM will let the user implement the solution, providing step by step support to the user. If the user does grants permission to the AIM to fix the problem, then AIM will temporarily take over control of the user device to implement the solution through its Execution Module 8. If the problem is for instance in the area of computer support, AIM will adjust settings and perform the tests and actions defined in the selected method, step by step, until the problem is resolved. AIM will back up all changes it makes so that in the unlikely case that the method being implemented does not resolve the problem, the changes can be undone and an alternative method can then be attempted.

In the last step 9, AIM reports to the user the outcome of its work and relinquishes control over the device back to the user. This communication with the user is typically through natural language using a trained neural network, but a written log is generated as well to document the history of changes.

The field of application for artificial intelligence motors is wide, and it includes but is not limited to technical support of most systems requiring technical support, such as laptop computers, desktop computers, mainframe computers, minicomputers, tablets, smartphones, servers, data centers, networks, wifi systems, phone systems including 5G systems, any iot devices (Internet of Things, Internet enabled devices), any networked or electronically accessible devices (with or without Internet), and of course the complete field of all types of software, firmware and software applications, including Operating System software and user-oriented applications (mobile and desktop).

There is a need in the market for tech support that actually resolves problems. Using an analogy, any consumer can drive a car, without having to learn how to adjust the timing of the valves or tuning the engine or overhauling the transmission. With electronic technology, that is very often not the case. A level of technical sophistication is expected and assumed which creates a problem for many users of computers, smartphones and a host of other tech devices. The present invention can bring help to many consumers who would like to have an assistant who can fix problems, not give them advice or confusing information on how to address the problem themselves. The artificial intelligence motor of this invention provides that, amongst many other benefits.

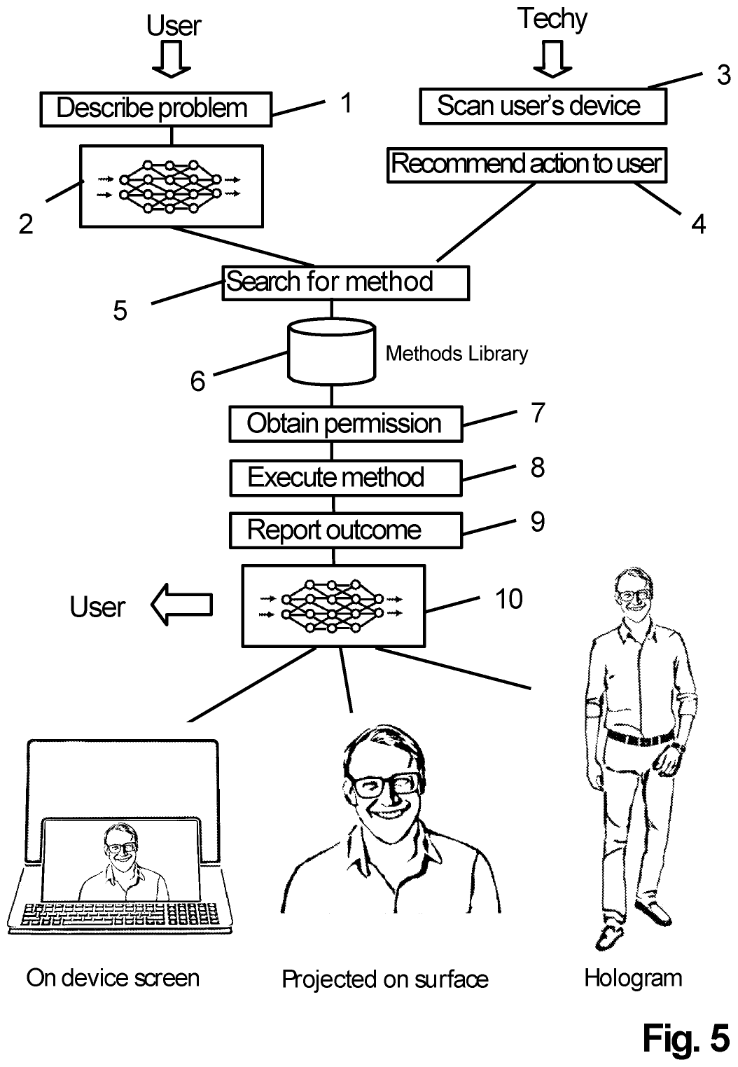

FIG. 5 shows the general methodology used by Techy, the Tech Support AIM, to perform its tech support functions. Action can be initiated either by the user by describing a technical problem they are experiencing (step 1), or alternatively, by Techy, who routinely scans the user's device (step 3) to assess the device's health and identify issues, threats, or necessary system maintenance. If Techy identifies any issues, threats, or needed maintenance, Techy proactively alerts the user to describe the problem and recommend action (step 4), which the user can accept or reject. If the user accepts the recommended action (or the user-initiated described in step 1), Techy searches for available methods (step 5) in the previously created Methods Library 6 for a possible solution to the problem. In step 7, Techy requests permission from the user to implement the selected method(s) and if permission is granted, it executes the method(s) in step 8. In step 9, Techy reports to the user the outcome of its work through the user's preferred communication settings (typically through natural language or messaging) with Techy either displayed on the user's device, projected on a surface, or projected as a hologram. Techy also maintains a written log to document the history of actions taken and tasks completed.

The system can be started by the user by voice by saying: Hi Techy.

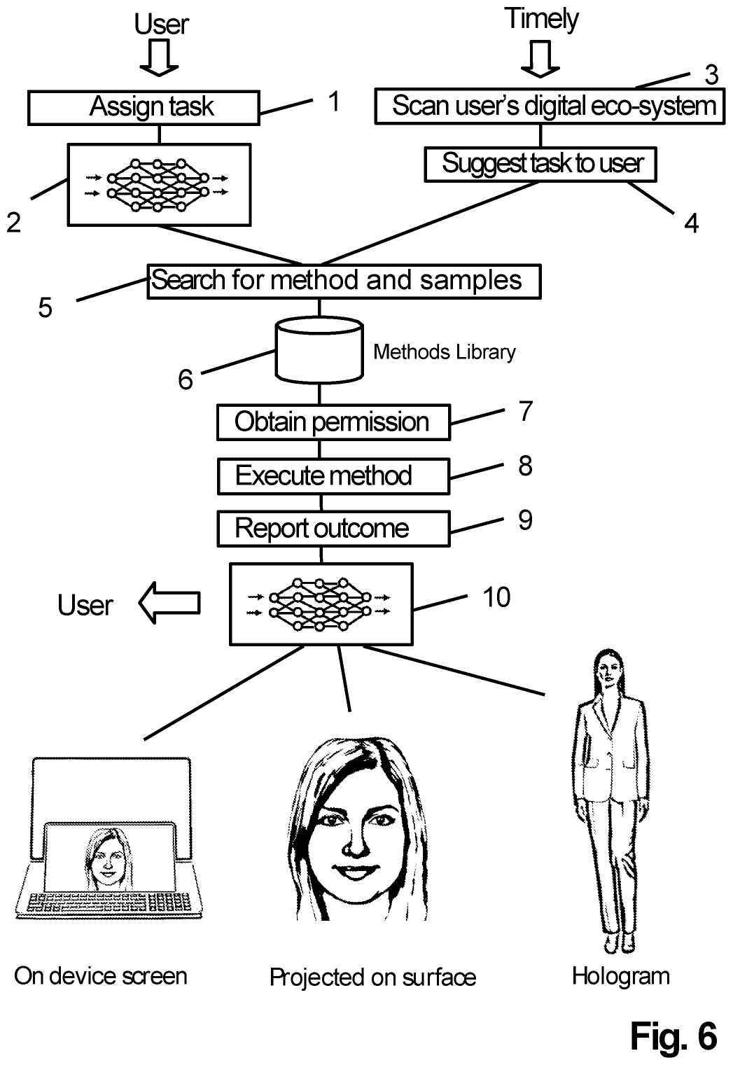

FIG. 6 shows another area of application for Artificial Intelligence Motors, which represents the next generation after virtual assistants. Virtual assistants have made significant progress and contributions with products such as Siri, Alexa and Google Assistant. These products are useful, but intended primarily for simple, limited and quick tasks. They focus primarily on the delivery of easily accessible information (“What is the weather report for today?”) and, to a lesser extent, executing simple tasks (“play Rod Stewart”). With the advent of the artificial intelligence motor of this invention, a new generation able to tackle even highly complex tasks is being born. Instead of a virtual assistant, the user will have an OM (Operations Manager). The OM can be completely customized, similarly to the way Techy can be customized for Tech Support. The user can choose appearance, face, gender, age, ethnicity, voice, accent, language and many other personalization parameters. The default name assigned to the OM in this invention is Timely. If the user asks Timely is he or she is an assistant, Timely will respond: “I am not an assistant. I'm your Operations Manager. I'm a doer, not just a talker. I can do many complex tasks for you and save you time, money and effort. Try me.”

The tasks that Timely can perform may fall into one or more of these categories:
tasks they may require multiple steps, which may be interdependent on each other (Step B is not only informed by Step A but cannot be executed without the completion of Step A.);
tasks that sometimes involve a time-lag between steps (steps may not be instantaneously executable);
tasks that involve interaction with one or more parties;
new tasks that may require the system to study the methods library or the user's ecosystem to learn about a possible solution; and
tasks that may require the system to ask the user for further clarification and preferences for the possible solution.

Examples of Complex Tasks that Timely can Perform Include:
Inventory management: “Check and order the inventory needed for next week's production run” (Step a: Pull up production goal for next week, Step b: Pull up current inventory levels, Step c: Flag items with low inventory and calculate quantity needed, Step d: Place order for quantities calculated in Step 3, Step e: Generate an order report for user.) Depending on the complexity of the operation and the availability of accessible software systems, Timely may interact with the MRP (Manufacturing Resources Planning) or ERP (Enterprise Resources Planning) system of the company.
Talent recruiting: The assigned task may be: “Pre-screen and qualify candidates for Job opening #7612, and send me short list of top three applicants” (Step a: Pull up all applicants, Step b: Filter based on criteria established in Methods Library, such as degree requirement), Step c: Sort remaining candidates based on criteria established in Methods Library, e.g. years of experience], Step d: Schedule virtual interview with top 20 candidates, Step e: conduct, record, and transcribe interviews using screener questions established in Methods Library, Step f: using NLP and sentiment analysis rank-order the candidates based on their interview responses, Step g: deliver a top three list of candidates.

Other Examples:
audit equipment (identify equipment in need of repair, maintenance, replacement);
generate a list of preferred suppliers for a purchased component;
prepare draft Quarterly/Annual statements;
prepare or qualify Business Plans;
generate Agenda for staff meetings;
generate Agenda and Minutesfor Board Meetings;
compose a social media post;
compose and send an email (draft) to a supplier or customer;
write a quotation (draft) for a customer;
generate and send an invoice (draft) to a customer (after approval by user), etc.

In order to be able to properly execute complex tasks, Timely will continuously study the behavior of the user and scan the device's storage media, emails, messages and phone calls (i.e., their “eco-system” in FIG. 6) for information about the user and the user's contacts, of course with prior permission from the user. This will also allow the OM to act proactively, not only reactive to specific user requests. Timely doesn't just wait for a request from the user, it can initiate action on its own. By scanning past workflows and calendars, the OM can offer to begin drafting annual performance reviews for direct reports, can offer to schedule and prepare for annual supplier reviews, offer to draft and broadcast RFPs for next quarter's projects, can offer to conduct the office's annual technology and equipment audit, and so forth. This is what human assistants do, they pay attention and study the boss and the company/office ecosystem, so they can help in a manner consistent with the style, position and responsibilities of the boss and the company. In our case, the user is the boss and Timely learns how and when to be a valuable contributor by recommending and executing important, complex tasks.

Like Techy, Timely's interface is completely customizable. Its default name is Timely, but it can be easily changed by the user. Timely will have a default appearance, but the user can select any desired appearance from an included AI appearance and face generator. Users can change Timely's default voice by selecting any desired voice from the included AI voice generator. Timely will listen, provide feedback and talk with the user using Natural Language. Timely's image will move its lips, face and body in perfect natural synchronization with Timely's image on the device screen. Timely can be completely customized by the user. Timely will be able to communicate using a device screen such as a laptop, tablet or smart phone, or by projecting an image of any desired size, such as a normal human size, on a surface such as a wall or on a projection screen, or through a hologram. The preferred communication method with the user will be natural language, but messaging will be supported too for those cases where it may be necessary or desirable.

FIG. 6 shows in detail the steps in the AIM Operations Manager methodology to recommend and/or execute complex tasks. The system can be started by the user by voice by saying: Hi Timely!

Action can be initiated either by the user by assigning a task in step 1, or alternatively, by Timely, who routinely scans the user's digital ecosystem (step 3) to obtain information and samples to identify potential tasks that the user may need or want. If Timely identifies a potential task, the system proactively alerts the user to suggest the task (step 4) to the user, at which point the user can accept or reject the task. In step 5, Timely searches a previously created Methods Library 6 for a possible method and informative samples to accomplish the task. In step 7, Timely requests permission from the user to implement the selected method(s) and to utilize the selected sample(s). If the user grants permission, Timely executes the selected method(s) (step 8).

In step 9, Timely reports to the user the outcome of its work through the user's preferred communication settings (typically through natural language or messaging) with Timely either displayed on the user's device, projected on a surface, or shown as a hologram. Timely also maintains a written log to document the history of actions taken and tasks completed.

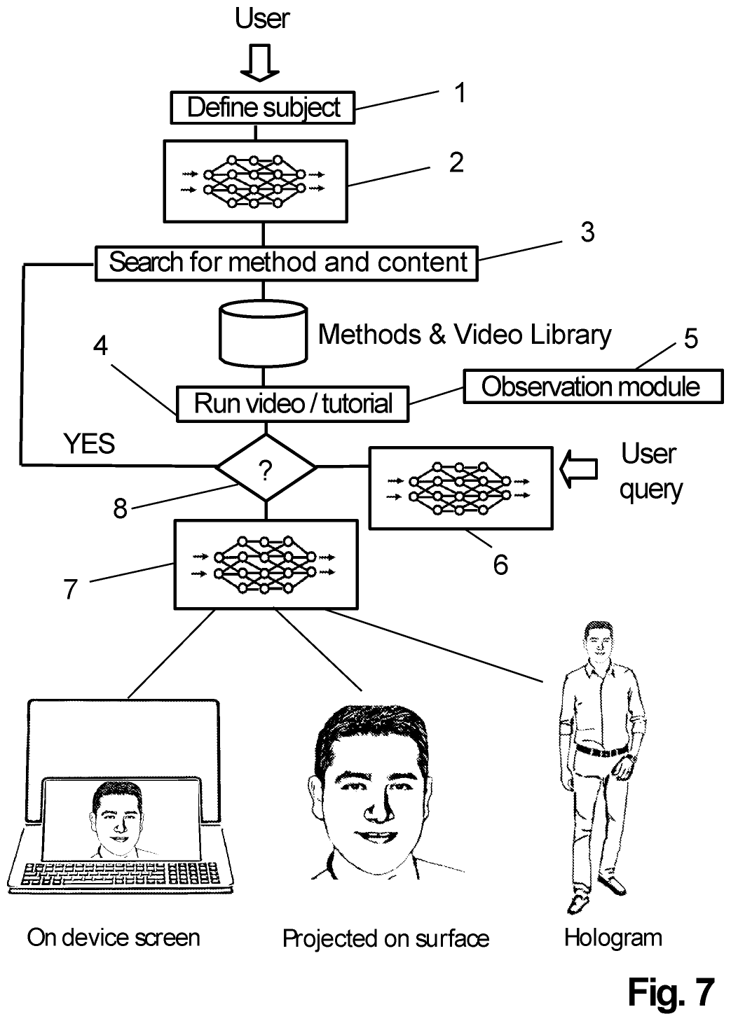

FIG. 7 shows another area of application for Artificial Intelligence Motors, which is online learning. Online learning is currently accomplished primarily through passive consumption of learning material (watching instructional videos), through tutorials with or without gamification, or through asynchronous communication (e-mailing or submitting quizzes and assignments to a tutor). While these methods are valuable, they lack an essential element to effective teaching, real-time observation of the student to gauge the student's understanding, points of confusions, and general interest in learning topics. Online instruction with a live person who tutors a student through synchronous communication (live chat, live video conferencing) is better at real-time observation but is costly and labor intensive. With the advent of the artificial intelligence motor of this invention, a new generation of AI powered online instruction is now possible.

Instead of a passive consumption or costly live tutoring, students can learn through an responsive online learning system, who has been assigned the default name Coach. Coach can be completely customized, similarly to the multiple ways Techy and Timely can be customized. The user can choose appearance, face, gender, age, ethnicity, voice, accent, language and many other personalization parameters. Coach allows content creators to generate instructional lessons that are non-linear and adaptive to the student's individual learning progress. Coach delivers instructional lessons through a responsive system that:
with the user's permission, accesses the user's microphone and camera to observe the student's facial expressions, vocal responses, eye movements, body language, body temperature and other manifestations of attitude;
identifies different learning states based on observing the student, including but not limited to: level of confusion (facial expression, vocal expressions of confusion); level of frustration (body temperature changes, body language); exact points of confusion (“wait, what? That makes no sense!”, raising a hand to request a pause in instruction); level of boredom (wandering eyes, fidgety body language), and levels of confidence (calm body language, shaking head yes to signal understanding);
reacts to perceived user attitude by adjusting the lesson delivery, such as when detecting signs of confusion or irritation, saying something like: OK, let me explain this last part in another way, and repeating the last part in a different, more understandable way.
solicits input from the student to gauge understanding level (administering a verbal pop quiz, having the student repeat the correct pronunciation when learning languages, having students physically demonstrate a skill (correct use of hands for ASL sign language);
based on the student's identified learning state and/or understanding level, recommends a learning task (provide additional examples, provide definitions, provide more in-depth learning modules for points of confusion, repeat an earlier lesson)
executes learning tasks specifically assigned by the student (“Please give another example”, “Please explain that in more simple terms”).
Solicits feedback and gauges level of understand after executing a learning task (“Did that example help? Would you like another example?”).

Content creators that utilize Coach provide the content of each lesson. Therefore, the system can be used to deliver responsive lessons on a diverse range of topics including but not limited to early-education, higher-education, hobbies, trades, technical skills, and HR/corporate training.

FIG. 7 shows in detail the steps in the AIM Responsive Coach methodology to provide responsive lessons. In step 1, the user defines the subject for example: “learn Adobe Illustrator”). A neural network 2 allows Coach to understand the verbal input from the user (of course written input such as messaging is available too for instances where it makes more sense). The lesson and the AIM Responsive Coach can be displayed either on the user's device, projected on a surface, or shown as a hologram, shown at the bottom of FIG. 7.

In step 3, the system searches the Methods and Video Library for available methods and content in the defined subject.

In step 4, Coach starts running the video tutorial.

In step 5, with user permission, Coach initiates observation mode by accessing the user's microphone for audio scans and/or the user's camera for visual scans. During visual scans, Coach scans for example: body gestures, body temperature, eye movement, and facial expressions. During audio scans, the system scans for example, spoken words and non-spoken vocal feedback (sounds of frustrations). Observation Mode can include the system proactively asking for user input (in the form of quizzes for example). The system uses the data gathered in observation mode to identify learning states (confused, frustrated, bored, engaged, confident) and level of understanding (low, average, high). Based on those learning states/level of understanding and sentiment, the system may recommend a learning task (offering additional examples for clarification, suggesting more advanced or less advanced lessons).

A key feature in this invention is the non-linear nature of the delivery of learning materials. Conventional prior art videos or tutorials are linear, meaning that the video will run continuously from beginning to end in a straight timeline, unless the user stops the process, rewinds or fast forwards, and then manually restarts the video. The content being delivered is also fixed and the user cannot change it. If the user doesn't understand some parr of the video, there are no provisions for resolving the issue, which could stop the learning process at that point.

By contrast, in this invention the video is non-linear and interactive. That is achieved by logical junction 8 in the flow diagram, which is constantly monitoring for user input. If there are user queries, the flow continues to step 7, where the materials are delivered to the user via video and natural language. However, if at any point a user query is detected (which is sent by neural network 6), then video delivery is stopped to listen to the query and loop back to the step 3, to search for a method and content to address the query. If content is found to respond to the query, the system delivers that explanatory content to the user and requests permission to resume the video. The user can make new and deeper queries as needed.

Queries give the lesson an interactive capability, preventing the user from getting stuck at some point. Sometimes a short explanation can get the user unstuck, and allowing the resumption of the lesson. In other cases, the system may insert a complete lesson on another topic (which possibly should have been a prerequisite), before resuming. The user can enter queries at any time by verbal or written questions or commands, such as: Explain; Repeat; What is XYZ? Define ABC. What? Wait! Backup. Back up 10 secs and repeat slowly, I don't get it, Go back to XYZ, Go back to previous step, etc.

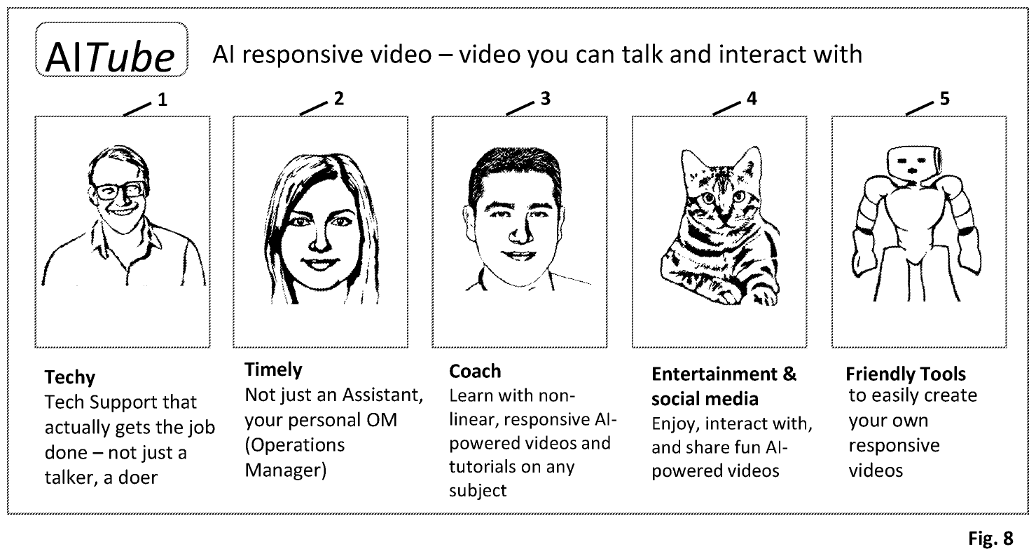

FIG. 8 shows AlTube, an online portal/website for watching and interacting with AI-powered video content, for accessing AI content creation tools, and for accessing the AI systems described above, such as Techy, Timely and Coach).

Section 1 provides access to the previously described AI Tech Support system (default name: Techy).

Section 2 provides access to the previously described AI Operations Manager system (default name: Timely).

Section 3 provides access to the previously described library of AI-powered responsive videos and lessons for learning new skills and knowledge in any field (default name: Coach). The content for lessons is mostly provided by users and therefore will include a very diverse range of topics from education, how-to-videos, and more.

Section 4 contains AI-powered responsive and conventional videos for entertainment and social media purposes. The content of these responsive, AI-powered videos is mostly supplied by posting users and may include diverse topics and contexts, including but not limited to humorous and entertaining content (such have a conversation with a cat) or any content that users find useful or desirable to generate and share.

Section 5 (Friendly Tools) includes a library of no-code or low-code tools that users can utilize to generate their own AI-powered videos. Those videos can be posted to Section 4, if they are primarily entertaining or social media in nature or they can be posted to Coach (Section 1) if they are instructional in nature. Users can post videos and keep them private, shareable with a defined audience only or with specific contacts or can be shared/embedded on user-specified external social media sites.

The above descriptions are exemplary in nature and are not intended to limit the scope of the invention. It is understood that a person skilled in the art could conceive many variations of the present invention in light of the present disclosures and all those variations and nuances are still within the scope of the invention.

What is claimed:

1. A hybrid artificial intelligence system able to emulate human problem-solving skills, comprising:
i. one or more inductive artificial intelligence modules, which can process large amounts of data in a computer system to extract features and patterns from the data, and store the results in a computerized methods library;
ii. a deductive artificial intelligence module, based on capturing known working principles, experience and practical rules of thumb in a computerized methods library; and
iii. a resolution algorithm that searches and finds a possible solution in the methods library.

2. The hybrid artificial intelligence system of claim 1, wherein the one or more inductive artificial intelligence modules includes one or more neural networks that can provide natural language processing, classification, recognition, regression, identification, and other capabilities well suited to data intensive inductive artificial intelligence.

3. The hybrid artificial intelligence system of claim 1, wherein the methods library contains possible solutions, working principles, pragmatic rules and decision trees based on past experience, which can instill a measure of practical knowledge and common sense into the system in its area of competence, which is an integral important element of human reasoning and decision making in real life situations.

4. The hybrid artificial intelligence system of claim 1, wherein action can be initiated either by the users or by the system itself acting in a proactive way

5. The hybrid artificial intelligence system of claim 1, wherein the AI system can learn autonomously by studying the ecosystem it operates in.

6. The hybrid artificial intelligence system of claim 1, wherein the system can be assigned a human appearance which can be totally customized and personalized by the user with multiple parameters such as face, appearance, age, ethnicity, gender, voice, language, accent, attire, attitude, facial expressions, gestures, lip syncing, and other parameters, to create familiarity and trust with the user.

7. The hybrid artificial intelligence system of claim 1, wherein the human appearance assigned to the system to interact with the human user can be an image displayed on a device, a projected image onto a surface, a hologram, or other suitable display methods.

8. An artificial intelligence motor, which is an artificial intelligence system that comprises:
i. the hybrid artificial intelligence system of claim 1;
ii. a permissions module, used by the user to grant or deny permission to implement a solution found by the system; and
iii. An execution module, which can actually implement the solution found.

9. The artificial intelligence motor of claim 8, wherein the artificial intelligence motor backs up the current status to be able to revert back to it if the proposed solution being implemented does not work out, and then tries to implement an alternative solution.

10. The artificial intelligence motor of claim 8, referred to as Techy in the specification, which is especially adapted and focused on Technical Support for technology-intensive products such as computers, smartphones, tablets, servers, communications, phone systems including 5G systems, Internet networks, IOT devices (Internet of Things), tablets, smartphones, servers, data centers, networks, wifi systems, phone systems including 5G systems, any networked or electronically accessible devices (with or without Internet), smart sports equipment, smart home appliances and devices, and all types of software, firmware and apps, including Operating System and BIOS level software, and user-oriented applications including but not limited to social media, entertainment and productivity software.

11. The artificial intelligence motor of claim 8, which is able to conduct the initial setup of at least one of hardware, software and firmware systems for the user, and later perform repair and recovery as needed.

12. The artificial intelligence motor of claim 8, which is especially adapted to and able to autonomously or semi-autonomously perform administrative and managerial tasks, collectively referred to herein as Operations Management, which include complex tasks such as, but not limited to, those tasks that require multiple steps, involve a time-lag between steps, require interaction with external parties, require the system to study the user's behavior and/or the user's ecosystem to find possible solutions and ways to execute a new task, and/or tasks that require clarification or preferences from the user.

13. The hybrid artificial intelligence system of claim 1, which is able to provide interactive and responsive online learning to users, by continuously gauging user attitude visually and acoustically, and continuously waiting for user's verbal or textual input or cues, with the ability to react to it in real time and alter the content being delivered as a result of said perceived attitude or input.

14. A responsive non-linear video system wherein user's commands or signals to the video system cause a departure from the normal delivery of the video, by pausing the video and instead immediately triggering the delivery of an alternative segment of video that can be used to provide clarification, increased level of detail or to address any user needs or requests, and subsequently resume the delivery of the main video.

15. The responsive non-linear artificially intelligent non-linear video of claim 15, wherein the user's commands and signals can be visual, acoustic, textual or attitudinal, including expressions of emotions, exasperation, satisfaction or any other emotions, and gestures, which the system detects and immediately responds to with a change in the delivery of the video.

16. The responsive artificially intelligent non-linear video of claim 15, wherein the changes in the delivery of the video can be nested, meaning that while an alternative video segment is being delivered, a new user command or signal can trigger an additional video segment being triggered and delivered.

17. Software tool for the creation of the non-linear videos of claim 14, based on either: a) the software tool running and analyzing the main video and then suggesting breakpoints and content where alternative video segments could be inserted, and then the software tool generating the code to implement the solution; or b) the user manually defining breakpoints and content where alternative video segments could be inserted and the software tool generating the code to implement that solution.
